(19) United States
(12) Patent Application Publication
(10) Pub. No.: US 2025/0084201 A1
(43) Pub. Date: Mar. 13, 2025

(54) PROCESSES FOR POLYETHER POLYOL PURIFICATION AND PREPARATION

(71) Applicant: SHELL USA, INC., Houston, TX (US)

(72) Inventors: Johannes Leendert Willem Cornelis DEN BOESTERT, Amsterdam (NL); Johannes Pieter HAAN, Amsterdam (NL); Michiel Barend ELEVELD, Amsterdam (NL); Prashant Anil TATAKE, Amsterdam (NL); Pranaya Man Singh PRADHAN, Singapore (SG); Paul DAVIS, Bangalore North (IN)

(21) Appl. No.: 18/727,372

(22) PCT Filed: Jan. 27, 2023
(86) PCT No.: PCT/EP2023/051987

§ 371 Date: Jul. 9, 2024

(30) Foreign Application Priority Data
Jan. 28, 2022 (EP) 22153981.0

(51) Int. Cl. C08G 18/48; C08G 18/16

(52) U.S. Cl. CPC C08G 18/4895; C08G 18/165; C08G 2110/0083; C08G 2650/68

(57) ABSTRACT

The invention relates to a process for purification of a polyether polyol which is prepared by ring-opening polymerization of an alkylene oxide in the presence of an initiator having a plurality of active hydrogen atoms and a composite metal cyanide complex catalyst, has a number average molecular weight of at most 10,000 g/mol and contains ultra-high molecular weight (UHMW) components having molecular weights of at least 3 times the number average molecular weight, said process comprising filtering the polyether polyol with a membrane having an average pore size of from 0.5 to 80 nm to produce a permeate comprising a purified polyether polyol containing a reduced amount of UHMW components. Further, the invention relates to a process for preparing a polyether polyol from the purified polyether polyol; and to a process for preparing a polyurethane foam.

### FIELD OF THE INVENTION

The present invention relates to a process for polyether polyol purification; to a process for preparing a polyether polyol from the purified polyether polyol; to a process for preparing a polyurethane foam using the purified polyether polyol or the polyether polyol prepared from the purified polyether polyol; to a polyurethane foam obtainable by said process; and to a shaped article comprising said polyurethane foam.

### BACKGROUND OF THE INVENTION

Polyurethane foams, in specific flexible polyurethane foams, have found extensive use in a multitude of industrial and consumer applications. For some applications, it is required that flexible polyurethane foams have a high resilience. A high resilience in a foam means that the foam, when used for example in cushions, provides better comfort properties. High-resilience (HR) polyurethane foams generally have a resilience of at least 40%.

Polyurethane foams are made by reacting a polyether polyol and a polyisocyanate in the presence of a blowing agent. In order to produce high-resilience (HR) polyurethane foams, polyols containing longer, elastic polyether chains are generally used.

Generally, polyether polyols are prepared by ring-opening polymerization of an alkylene oxide in the presence of an initiator having a plurality of active hydrogen atoms and a catalyst. Said alkylene oxide may be propylene oxide (PO) and/or ethylene oxide (EO). Further, said catalyst may be a basic catalyst, such as potassium hydroxide (KOH), or a composite metal cyanide complex catalyst, which latter catalyst is frequently also referred to as double metal cyanide (DMC) catalyst. Advantages associated with DMC-catalysed production of polyether polyols is that it is faster and more efficient than the traditional KOH-catalysed process. Further, the DMC-catalysed process can be run on a continuous system, rather than as a batch process, further increasing its efficiencies. Still further, the DMC-catalysed process is more environmentally friendly and has a decreased carbon (CO₂) footprint.

Generally, high-resilience (HR) polyurethane foams are made using polyether polyols having a relatively high molecular weight, for example 4,500 g/mol or higher, and a relatively high primary hydroxyl content (PHC), for example of from 60% to 100%. A relatively high primary PHC can be achieved by ensuring that in the last part of the polyether polyol preparation process, a relatively high amount of ethylene oxide (EO), which provides a primary hydroxyl group upon ring-opening, is present and no or a relatively low amount of other alkylene oxides, such as propylene oxide (PO), which mainly provide secondary hydroxyl groups upon ring-opening. Such a process is referred to as “EO-tipping”.

The use of such HR polyether polyols is for example disclosed in U.S. Pat. No. 8,901,187B1, which discloses that an HR polyether polyol may be a polyalkyleneoxide polyether glycol having a molecular weight of from 4,500 to 6,000 g/mol, with 12 to 20 wt. % of ethylene oxide groups and the remaining 80 to 88 wt. % being propylene oxide groups, while having a hydroxyl functionality ranging from 2 to 8. In the Examples of U.S. Pat. No. 8,901,187B1, a “Polyol 1” is used which is described as an EO-tipped HR polyether polyol having a molecular weight of 4, 800 g/mol and an OH value of 35 mg KOH/g.

In practice, EO-tipping is only achieved using a KOH-catalysed polyether formation reaction. When attempting to use double metal cyanide (DMC) catalysts in the EO-tipping process, the combination of the more active catalyst and the inherent activity of primary OH groups results in long chains of EO on only a few of the polyether chains rather than the EO content being evenly distributed over all of the polyether chains.

It has been found that when preparing a high-resilience (HR) polyurethane foam using a polyether polyol having been, wholly or partly, prepared in the presence of a composite metal cyanide complex catalyst (DMC catalyst), the foam thus produced may be unstable, in specific as shown by a so-called “sink back” of the foam and/or by a relatively low foam height (low foam rise) and/or even by a collapse of the foam. Said sink back refers to a phenomenon wherein after reaching a certain height the foam height is reduced. A disadvantage of such sink back is that the final foam density is not distributed evenly and/or that the final foam height is relatively low.

It is an object of the present invention to provide a DMC-catalysed polyether polyol, which is at least partly made using a DMC catalyst, such DMC catalyst use resulting in the above-mentioned advantages as compared to a (wholly) KOH-catalysed polyether polyol preparation process, for use in a process for the production of a polyurethane foam, especially a high-resilience (HR) polyurethane foam, wherein the polyurethane foam thus produced may have an increased stability which may be evidenced by not suffering from the above-mentioned disadvantages including foam sink back and/or low foam height and/or foam collapse.

### SUMMARY OF THE INVENTION

Surprisingly it was found that such object may be achieved by first at least partially removing ultra-high molecular weight (UHMW) components from a polyether polyol obtained by a DMC-catalysed process, by subjecting it to a filtration treatment involving filtering the polyether polyol with a membrane having an average pore size of from 0.5 to 80 nm (nanometres) resulting in a reduced amount of UHMW components in the purified polyether polyol.

Accordingly, the present invention relates to a process for purification of a polyether polyol which is prepared by ring-opening polymerization of an alkylene oxide in the presence of an initiator having a plurality of active hydrogen atoms and a composite metal cyanide complex catalyst, has a number average molecular weight of at most 10,000 g/mol and contains ultra-high molecular weight (UHMW) components having molecular weights of at least 3 times the number average molecular weight, said process comprising filtering the polyether polyol with a membrane having an average pore size of from 0.5 to 80 nm to produce a permeate comprising a purified polyether polyol containing a reduced amount of UHMW components.

Further, the present invention relates to a process for preparing a polyether polyol which has a molecular weight of at least 4,000 g/mol and a primary hydroxyl content of at least 30%, said process comprising ring-opening polymerization of an alkylene oxide comprising ethylene oxide in the presence of a polyether polyol obtained by the above-mentioned purification process and a basic catalyst.

Further, the present invention relates to a process for preparing a polyurethane foam, comprising reacting a polyether polyol, which comprises the above-mentioned purified polyether polyol or the above-mentioned polyether polyol prepared from said purified polyether polyol, and a polyisocyanate in the presence of a blowing agent.

Further, the present invention relates to a polyurethane foam obtainable by the above-described process, and to a shaped article comprising said polyurethane foam.

### BRIEF DESCRIPTION OF THE DRAWINGS

FIG. 1 illustrates one embodiment of the process of the present invention having a single filtration unit.

FIG. 2 illustrates another embodiment of the process of the present invention having a staged filtration unit.

### DETAILED DESCRIPTION OF THE INVENTION

While the processes and compositions of the present invention may be described in terms of “comprising”, “containing” or “including” one or more various described steps and components, respectively, they can also “consist essentially of” or “consist of” said one or more various described steps and components, respectively.

In the context of the present invention, in a case where a composition comprises two or more components, these components are to be selected in an overall amount not to exceed 100 wt. %.

Where upper and lower limits are quoted for a property then a range of values defined by a combination of any of the upper limits with any of the lower limits is also implied.

The term “molecular weight” (or “MW”) is used herein to refer to number average molecular weight, unless otherwise specified or context requires otherwise. The number average molecular weight of a polyol can be measured by gel permeation chromatography (GPC) or vapor pressure osmometry (VPO).

The term “hydroxyl (OH) value” or “hydroxyl (OH) number” is used herein to refer to the milligrams of potassium hydroxide equivalent to the hydroxyl content in one gram of polyol determined by wet method titration. Hence, said OH value or number is expressed in mg KOH/g.

The term “equivalent weight” (or “EW”) is used herein to refer to the weight of polyol per reactive site. The equivalent weight is 56, 100 divided by the hydroxyl value of the polyol.

The term “functionality” or “hydroxyl (OH) functionality” of a polyol refers to the number of reactive hydroxyl sites per molecule of polyol. The nominal functionality (or “Fn”) of a polyol is the same as that of its starter compound (initiator). Unless indicated otherwise, functionality refers to the actual average functionality which may be lower than the nominal functionality and is determined by the number average molecular weight of the polyol divided by the equivalent weight of the polyol.

The term “primary hydroxyl content” (or “PHC”) is used herein to refer to the relative proportion (in %) of primary hydroxyl groups in a polyether polyol based on total number of hydroxyl groups including primary and secondary hydroxyl groups.

The terms “ethylene oxide content” and “propylene oxide content”, respectively, in relation to a polyether polyol refer to those parts of the polyol which are derived from ethylene oxide and propylene oxide, respectively. Said contents may also be referred to as oxyethylene content and oxypropylene content, respectively. Further, said contents are based herein on total alkylene oxide weight.

The present invention relates to a process for purification of a polyether polyol which (i) has a number average molecular weight of at most 10,000 g/mol and (ii) contains ultra-high molecular weight (UHMW) components having molecular weights of at least 3 times the number average molecular weight.

In the present invention, the polyether polyol to be purified has a number average molecular weight of at most 10,000 g/mol, suitably of from 1,000 to 10,000 g/mol, more suitably of from 1,500 to 7,000 g/mol, most suitably of from 2,000 to 5,000 g/mol. Said molecular weight is preferably at least 500 g/mol, more preferably at least 1,000 g/mol, more preferably at least 1,500 g/mol, more preferably at least 2,000 g/mol, most preferably at least 2,500 g/mol. Further, said molecular weight is at most 10,000 g/mol, preferably at most 8,000 g/mol, more preferably at most 7,000 g/mol, more preferably at most 6,000 g/mol, more preferably at most 5,000 g/mol, more preferably at most 4,000 g/mol, most preferably at most 3,500 g/mol.

Further, in the present invention, the polyether polyol to be purified contains ultra-high molecular weight (UHMW) components having molecular weights of at least 3 times the above-described number average molecular weight of the polyether polyol to be purified. Suitably, the UHMW components in the polyether polyol to be purified have molecular weights of at least 5 times or at least 10 times or at least 17 times or at least 33 times the number average molecular weight. Further, suitably, the UHMW components have molecular weights of at most 133 times or at most 33 times or at most 17 times or at most 10 times the number average molecular weight.

Further, in the present invention, the amount of the UHMW components having molecular weights as described above, in the polyether polyol to be purified, may be of from 100 to 10,000 parts per million by weight (ppmw), suitably 1,000 to 8,000 ppmw, more suitably 2,000 to 6,000 ppmw. Said UHMW content is preferably at least 50 ppmw, more preferably at least 100 ppmw, more preferably at least 500 ppmw, more preferably at least 1,000 ppmw, more preferably at least 1,500 ppmw, more preferably at least 2,000 ppmw, more preferably at least 2,500 ppmw, most preferably at least 3,000 ppmw. Further, said UHMW content is preferably at most 10,000 ppmw, more preferably at most 9,000 ppmw, more preferably at most 8,000 ppmw, more preferably at most 7,000 ppmw, more preferably at most 6,000 ppmw, more preferably at most 5,000 ppmw, more preferably at most 4,500 ppmw, most preferably at most 4,000 ppmw.

Further, in the present invention, the polyether polyol to be purified may contain ultra-high molecular weight (UHMW) components having molecular weights greater than 15,000 g/mol, suitably components having molecular weights in the range of from greater than 15,000 g/mol to 400,000 g/mol, suitably in an amount as described above

In the present invention, the polyether polyol to be purified may contain UHMW components having molecular weights greater than 15,000 g/mol to 30,000 g/mol in an amount of from 100 to 8,000 ppmw, suitably 1,000 to 7,000 ppmw, more suitably 2,000 to 5,000 ppmw. Further, said polyether polyol to be purified may contain UHMW components having molecular weights greater than 30,000 g/mol to 50,000 g/mol in an amount of from 10 to 1,000 ppmw, suitably 50 to 800 ppmw, more suitably 100 to 500 ppmw. Further, said polyether polyol to be purified may contain UHMW components having molecular weights greater than 50,000 g/mol to 100,000 g/mol in an amount of from 1 to 500 ppmw, suitably 5 to 300 ppmw, more suitably 10 to 100 ppmw. Further, said polyether polyol to be purified may contain UHMW components having molecular weights greater than 100,000 g/mol to 400,000 g/mol in an amount of from 0 to 100 ppmw, suitably 1 to 60 ppmw, more suitably 5 to 30 ppmw.

The content of above-mentioned UHMW components in a polyether polyol may be measured in any way known to the skilled person, for example by liquid chromatography, in specific by high-performance liquid chromatography (HPLC).

In the present invention, the polyether polyol to be purified and to be subjected to the below-described filtration process, is a polyether polyol which is prepared by ring-opening polymerization of an alkylene oxide in the presence of an initiator having a plurality of active hydrogen atoms and a composite metal cyanide complex catalyst.

Any polyether polyol made by using a composite metal cyanide complex catalyst and containing UHMW components may be subjected to the below-described filtration process of the present invention.

Preferably, the polyether polyol to be purified comprises polyether chains containing propylene and/or butylene oxide content, more preferably propylene oxide (PO) content, and optionally ethylene oxide (EO) content. More preferably, the polyether polyol to be purified comprises polyether chains containing propylene oxide content and ethylene oxide content.

Preferably, the polyether polyol to be purified comprises polyether chains containing of from 0 wt. % to 25 wt. % of EO content. The EO content of the polyether polyol may be at most 25 wt. % or at most 20 wt. % or at most 15 wt. % or at most 12 wt. %. Further, the EO content of the polyether polyol may be 0 wt. % or at least 3 wt. % or at least 5 wt. % or at least 6 wt. % or at least 10 wt. % or at least 12 wt. % or at least 15 wt. %.

Preferably, the remainder of the alkylene oxide content in the polyether chains of the polyether polyol to be purified is derived from propylene and/or butylene oxide. More preferably, the remainder of the alkylene oxide content in the polyether chains of the polyether polyol is derived from propylene oxide. Therefore, the polyether chains of the polyether polyol preferably comprise at least 75 wt. %, more preferably at least 80 wt. %, most preferably at least 85 wt. of propylene oxide (PO) content. Further, the polyether chains of the polyether polyol may comprise 100 wt. % of PO content and preferably comprise at most 97 wt. %, more preferably at most 95 wt. %, most preferably at most 94 wt. of PO content.

In the present invention, the polyether chains of the polyether polyol to be purified may comprise no ethylene oxide content but may comprise only propylene and/or butylene oxide content, suitably only propylene oxide content.

Further, the polyether polyol to be purified preferably has a hydroxyl value of at least 15, more preferably at least 20, more preferably at least 25, more preferably at least 35, most preferably at least 45. Further, the polyether polyol preferably has a hydroxyl value of at most 80, more preferably at most 70, more preferably at most 65, more preferably at most 50, more preferably at most 40, most preferably at most 35.

In preparing the polyether polyol to be purified, said initiator having a plurality of active hydrogen atoms may have a hydroxyl (OH) functionality of from 2 to 8, preferably 2 to 4, more preferably 2 to 3. Such initiator may suitably comprise one or more of monopropylene glycol, glycerol, trimethylolpropane, pentaerythritol, sorbitol and mannitol, preferably one or more of monopropylene glycol, glycerol and trimethylolpropane, more preferably monopropylene glycol or glycerol, most preferably glycerol. It is especially preferred to use a combination of monopropylene glycol and glycerol. The polyether polyol to be purified may have a hydroxyl (OH) functionality which is at least 2. The latter functionality may be of from 2 to 8, preferably 2 to 4, more preferably 2 to 3.

Thus, in preparing the polyether polyol to be purified, a composite metal cyanide complex catalyst is used. Composite metal cyanide complex catalysts are frequently also referred to as double metal cyanide (DMC) catalysts. A composite metal cyanide complex catalyst is typically represented by the following formula (1):

M¹ₐ[M²_{b}(CN)_{c}]_{d}·e(M¹_{f}X_{g})·h(H₂O)·i(R) (1)
wherein each of M¹ and M² is a metal, X is a halogen atom, R is an organic ligand, and each of a, b, c, d, e, f, g, h and i is a number which is variable depending upon the atomic balances of the metals, the number of organic ligands to be coordinated, etc.

In the above formula (1), M¹ is preferably a metal selected from Zn(II) or Fe(II). In the above formula, M² is preferably a metal selected from Co(III) or Fe(III). However, other metals and oxidation states may also be used, as is known in the art.

In the above formula (1), R is an organic ligand and is preferably at least one compound selected from the group consisting of an alcohol, an ether, a ketone, an ester, an amine and an amide. As such an organic ligand, a water-soluble one may be used. Specifically, one or more compounds selected from tert-butyl alcohol, n-butyl alcohol, iso-butyl alcohol, tert-pentyl alcohol, isopentyl alcohol, N,N-dimethyl acetamide, glyme (ethylene glycol dimethyl ether), diglyme (diethylene glycol dimethyl ether), triglyme (triethylene glycol dimethyl ether), ethylene glycol mono-tert-butylether, iso-propyl alcohol and dioxane, may be used as organic ligand(s). The dioxane may be 1,4-dioxane or 1,3-dioxane and is preferably 1,4-dioxane. Most preferably, the organic ligand or one of the organic ligands in the composite metal cyanide complex catalyst is tert-butyl alcohol. Further, as an alcohol organic ligand, a polyol, preferably a polyether polyol may be used. More preferably, a poly(propylene glycol) having a number average molecular weight in the range of from 500 to 2,500 Dalton, preferably 800 to 2,200 Dalton, may be used as the organic ligand or one of the organic ligands. Most preferably, such poly(propylene glycol) is used in combination with tert-butyl alcohol as organic ligands. The composite metal cyanide complex catalyst can be produced by known production methods.

In the present invention, the polyether polyol to be purified is preferably not an “EO-tipped” polyether polyol. That is to say, if EO is present, the EO content is not present solely at the ends of the polyether chains. Typically, the ethylene oxide content present in the polyether chains of the polyether polyol is distributed, preferably randomly, within the polyether chains. Therefore, the polyether polyol to be purified and resulting from ring-opening polymerization of an alkylene oxide using a DMC catalyst as the only catalyst, may have a relatively low primary hydroxyl content (PHC) which may be at most 25% or at most 18% or at most 13%. Further, the PHC for such polyether polyol may be at least 2% or at least 6% or at least 8%.

It is also envisaged in the present invention to purify polyether polyols resulting from ring-opening polymerization of an alkylene oxide using a DMC catalyst as the only catalyst but still having a relatively high PHC which may be at least 30% or at least 40% or at least 45%. Further, the PHC for such polyether polyols may be at most 70% or at most 65% or at most 60% or at most 55%. Such polyether polyols are frequently also referred to as “pseudo-EO-tipped” polyether polyols. And they may be prepared in a way as described in WO2017003749, the disclosure of which is incorporated herein by reference. In a first step, a polyether polyol is prepared using a DMC catalyst in a way as described above resulting in an EO content of at most 25 wt %, suitably of from 3 to 25 wt. %, a relatively low PHC of at most 25%, suitably of from 2 to 25%. Then, in a final step, said polyether polyol is further polymerized also using a DMC catalyst but adding an increasing amount of ethylene oxide. In such final step, an alkylene oxide mixture comprising ethylene oxide and propylene oxide and/or butylene oxide, preferably ethylene oxide and propylene oxide, is added, either continuously or intermittently, wherein the concentration of ethylene oxide in said mixture is increased, either continuously or intermittently, until the mixture contains 60 to 100 wt. % of ethylene oxide and 0 to 40 wt. % of propylene oxide and/or butylene oxide. It is preferred to increase the concentration of ethylene oxide in the mixture until a final (highest) value of at least 70 wt. %, more preferably at least 75 wt. %, more preferably at least 80 wt. %, more preferably at least 85 wt. %, more preferably at least 90 wt. %, most preferably at least 95 wt. %.

The polyether polyol to be purified may be prepared by only using a DMC catalyst, that is to say wholly made using a DMC catalyst. However, the polyether polyol to be purified may also be partly made using a DMC catalyst. In specific, it may be prepared by first preparing a polyether polyol using a DMC catalyst in a way as described above resulting in an EO content of at most 25 wt %, suitably of from 3 to 25 wt. %, a relatively low PHC of at most 25%, suitably of from 2 to 25%, followed by using a basic catalyst to further polymerize said polyether polyol in a final step. Preferably, said basic catalyst is a potassium hydroxide (KOH) catalyst. Such final step comprises ring-opening polymerization of an alkylene oxide comprising ethylene oxide in the presence of (i) a basic catalyst and (ii) the polyether polyol prepared by using a DMC catalyst. The higher the relative amount of ethylene oxide in such final step, the higher the PHC of the resulting polyether polyol. It is preferred that in the final step, only ethylene oxide is added as alkylene oxide. The polyether polyol prepared by a process involving such final step, and to be purified by the purification process of the present invention, comprises polyether chains containing preferably at most 30 wt. %, more preferably at most 25 wt., most preferably at most 20 wt. % of ethylene oxide (EO) content. Further, preferably, such polyether polyol comprises polyether chains containing at least 5 wt. %, more preferably at least 8 wt. %, most preferably at least 12 wt. % of EO content. Still further, preferably, such polyether polyol has a primary hydroxyl content (PHC) which is at most 99% or at most 95% or at most 90% or at most 85% or at most 80%. Further, the PHC for such polyether polyol may be at least 50% or at least 60% or at least 65% or at least 70% or at least 75%. Such polyether polyols are frequently also referred to as “EO-tipped” polyether polyols. That is to say, EO content is present at the ends of the polyether chains. For said “EO-tipped” polyether polyols, in the present invention, the weight ratio of alkylene oxide added when using the DMC catalyst to alkylene oxide added when using the basic catalyst may be of from 1:1 to 10:1, preferably of from 3:1 to 9:1, more preferably of from 4:1 to 8:1.

In the purification process of the present invention, a membrane is used to filter the above-described polyether polyol. The membrane may be organophilic or hydrophilic. Preferably, the membrane is hydrophilic. Generally, it would be understood that a hydrophobic membrane would be appropriate for filtering hydrocarbon streams (see, for example, U.S. Pat. No. 6,488,856). Further, it is generally understood that hydrophobic membranes are less prone to fouling.

The material of the membrane is selected to be compatible with the components contained in the liquid hydrocarbon feedstock stream. Preferably, the membrane is an inorganic membrane, a polymer membrane, or a combination thereof. More preferably, the membrane is a ceramic membrane or a composite ceramic membrane.

Membranes have an asymmetric structure. An asymmetric structure provides an amorphous pore network with a smallest or controlling pore size that could be suitable for the process.

In the present invention, the membrane has an average pore size of from 0.5 to 80 nm. Preferably, the membrane has an average pore size of from 0.5 to 25 nm, more preferably 1 to 25 nm, more preferably 5 to 25 nm. The average pore size of the membrane is at least 0.5 nm, preferably at least 0.8 nm, more preferably at least 1 nm, more preferably at least 3 nm, more preferably at least 4 nm, most preferably at least 5 nm. The average pore size of the membrane is at most 80 nm, preferably at most 60 nm, more preferably at most 45 nm, more preferably at most 35 nm, more preferably at most 25 nm, more preferably at most 20 nm, more preferably at most 15 nm, most preferably at most 12 nm.

Further, preferably, the membrane has a molecular weight cut-off value (MWCO) in a range of from 1,000 to 100,000 Daltons (Da), more preferably 4,000 to 80,000, more preferably 6,000 to 60,000, more preferably 7,000 to 40,000, most preferably 8,000 to 20,000 Da. By MWCO, we mean 90% of solute having a specified molecular weight is retained by the membrane.

The membrane may be a composite membrane of a first membrane layer and a second membrane layer. The first membrane layer provides support and can be a porous polymer, a porous cross-linked polymer, a porous pyrolyzed polymer, a porous pyrolyzed cross-linked polymer, a porous metallic structure, a hybrid metallic-polymer porous structure, or a porous ceramic structure. The second membrane layer can be formed on the porous support structure and is a polymer membrane layer. The composite membrane may be a composite of ceramic and polymer, for example a polymer membrane layer on a ceramic membrane layer or a polymer grafted onto a ceramic membrane.

Thus, the membrane may be a composite of a polymer and a support selected from the group consisting of a porous polymer, a porous cross-linked polymer, a porous pyrolyzed polymer, a porous pyrolyzed cross-linked polymer, a porous metallic structure, a hybrid metallic-polymer porous structure, a porous ceramic structure, and combinations thereof.

Examples of polymeric materials suitable to make the membrane are polyimides. Suitable commercially available polymeric materials comprise MATRIMID 5218™ (Huntsman), PYRALIN PI 2566™ (6FDA-ODA polyamic acid, by Du Pont), P84™ (Lenzing), TORLON™ (Solvay), polyphenylene oxide NORYL™ (PPO, Sabic), polyetherimide (Sigma Aldrich) and a BPDA-based polyimide in hollow fibre form (Ube). Other polymeric materials suitable for making dense membranes suitable for this invention are polysiloxane-based, in particular from poly(dimethyl siloxane) (PDMS).

Examples of suitable cross-linked polymeric membranes are membranes comprising per-fluoropolymers derived from perfluoro cycloalkene (PFCA), ethylene, vinyl fluoride (VF1), vinylidene fluoride (VDF), trifluoro ethylene (TrFE), tetrafluoroethylene (TFE), chlorotrifluoroethylene (CTEF), propylene, hexafluoropropylene (HFP), perfluoropropylvinylether (PPVE), perfluoromethylvinylether (PMVE) or a combination thereof which further may contain at least one chlorinated monomer such as chlorofluoroethylene (CFE), chlorotrifluoroethylene (CTFE), 2-chloro-3,3,3-trifluoropropene, 1-chloro-3,3,3-trifluoropropene. The copolymer may further contain at least one other unit derived from a fluorinated monomer, which may be chosen from: tetrafluoroethylene (TFE), hexafluoropropylene (HFP), 2-(trifluoromethyl)acrylic acid, trifluoro-propene, tetrafluoropropene, hexafluoroisobutylene, (perfluorobutyl)ethylene, pentafluoropropene, perfluoro-alkyl ethers such as PMVE, PEVE, and PPVE and mixtures thereof. Preferably, the membrane is a per-fluoropolymer copolymerized with tetrafluoroethylene. More generally, suitable polymers may include glassy polymers, polymers with high intrinsic micro porosity, and/or polymers that are known to form a porous carbon structure when the cross-linked polymer is exposed to pyrolysis conditions. Other polymeric materials suitable for making the porous support of a membrane are PolyAcryloNitrile (PAN), PolyAmideImide+TiO2 (PAT), PolyEtherImide (PEI), PolyvinylideneDiFluoride (PVDF), and porous PolyTetraFluoroEthylene (PTFE).

When a polymer is used to form the membrane, it can be cross-linked and/or pyrolyzed prior to use to increase the stability of the membrane structure. Furthermore, cross-linking may be desirable prior to pyrolysis. The polymeric membrane structure can be converted to a porous carbon structure after pyrolysis where the desirable pore structure can be maintained by cross-linking of the material.

Preferably, the membrane is a ceramic membrane or a functionalized inorganic membrane, in particular, a functionalized ceramic membrane. Hereby, functionalization refers to the chemical surface modification, wherein “surface’ is understood to comprise the (macroscopic) outer surface of the inorganic membrane as well as the inner pore surfaces of the matrix making up the inorganic membrane. It typically involves the replacement of the hydroxyl (—OH) groups provided on the surface of the inorganic membrane by organic functional groups. Preferably, the functionalized internal and external surface of the membrane reduces fouling relative to a non-functionalized ceramic membrane. For example, by functionalizing the membrane surface, surface wettability may be improved, which may enhance the permeability.

Ceramic membranes are known to comprise chemically inert, high-temperature stability, and anti-swelling properties when subjected to optimal conditions. Such membranes include narrow and well-defined pore size distribution, in comparison to polymeric membranes, which allows ceramic membranes to achieve a high degree of particulate removal at high flux levels.

Ceramic membranes may include, for example, mesoporous titania, mesoporous gamma-alumina, mesoporous zirconia, and mesoporous silica, suitably mesoporous titania. Suitable inorganic membranes may also consist of inorganic materials (e.g., sintered metals, metal oxide, metal nitride and metal carbide materials) including a porous support, one or more layers of decreasing pore diameter, and an active or selective layer (e.g., gamma-alumina, zirconia, etc.) covering an internal surface of the membrane element.

Commercially available ceramic membranes often have at least two layers including a macroporous support layer and a thin selective layer, commonly there is a mesoporous intermediate layer between the microporous support and the selective layer. The thickness of the selective membrane layer determines the transport rate across the membrane. It can be selected in the range of from 0.08 μm to 5 μm. In addition, the second membrane layer may be provided with enough pores to enable acceptable transport rates. The amount of pores is determined by the specific surface area of the second membrane layer which can be measured by nitrogen adsorption (BET) and can be in the range of from 10 m²/g to 1000 m²/g for pores having sizes in the range of from 5 Angstroms to 100 Angstroms.

Functionalized inorganic membranes can be fabricated by 1) grafting organic molecules on the surface of the inorganic material by means of post-modification treatment(s), 2) building-in organic linkers within the inorganic matrix. The basis of such membranes is that the inorganic support provides mechanical strength to the membrane without significant flow resistance.

The support may be composed of ceramics, glass ceramics, glasses, metals, and combinations thereof. Examples of suitable supports include, but are not limited to, metals (such as, stainless steels or Ni-alloys), metal oxides (such as but not limited to, alumina (e.g., alpha-alumina, gamma-alumina, or combinations thereof), cordierite, mullite, aluminium titanate, titania, ceria, magnesia, silicon carbide, zirconia, zircon, zirconates, zirconia-spinel, spinel, silicates, borides, alumino-silicates, porcelain, lithium alumino-silicates, feldspar, magnesium alumino-silicates, and fused silica, suitably titania.

Nominal pore size of the support typically ranges from about 1 μm to about 10 μm, but may also be less than about 1 μm, particularly less than about 800 nm. The preferred pore size of the inorganic porous support is in the range of from 0.1 to 0.5 μm, more preferably 0.2 to 0.5 μm. Commercially available inorganic porous supports can be sourced from many different sources known to those skilled in the art, including, without limitation, Inopor GmbH, Hyflux LTD., Fraunhofer IKTS, Atech, Liqtech, TAMI, and Evonik MET.

The functionalization of the surface of the inorganic porous support may be carried out by binding an organic functional group linked to the inorganic membrane via a carbon bond or and oxygen bond to a component within the inorganic membrane which can be a metal such as Ti, Zr, Al, Si, Ge, Mg, Ca, Ba, Ce, Gd, Sr, Y, La, Hf, Fe, Mn, or a combination thereof. Preferably, the organic functional group is selected from the group consisting of (a) haloalkyl, preferably fluoroalkyl or perfluoroalkyl, more preferably fluoro-C1-C16-alkyl or perfluoro-C1-C16-alkyl, more preferably fluoro-C1-C8-alkyl or (per) fluoro-C1-C8-alkyl; (b) aryl, preferably C6-C16 aryl, more preferably C6-C10 aryl; and (c) haloaryl, preferably fluoroaryl or perfluoroaryl, more preferably fluoro-C6-C16-aryl or perfluoro-C6-C16-aryl, more preferably fluoro-C6-C10-aryl or perfluoro-C6-C10-aryl. Furthermore, Grignard reagents are reported to be used for functionalization of a membrane surface (Hosseingabadi S R, et al., “Solvent-membrane-solute interactions in organic solvent nanofiltration (OSN) for Grignard functionalized ceramic membranes: Explanation via Spiegler-Kedem theory”, Journal of Membrane Science 513 (2016) 177-185). Further details of the functional groups that could be provided to the inorganic membrane are described in U.S. Pat. No. 10,730,022.

A functionalized hybrid membrane separates compounds on the basis of a partition coefficient (P), which describes the propensity of a neutral (uncharged) compound to dissolve in an immiscible biphasic system of lipids and water. The partition coefficient is a measure of how much of a solute dissolves in a water portion versus an organic portion. The measure may be reported as a ‘Log P’ value, where it is calculated from the log 10 of P where P is a ratio of the concentration of a compound in an organic phase over the concentration of the compound in an aqueous phase. Thus, because of the functionalization of the porous inorganic membrane surface, the membrane, having a hydrophobic nature, allows permeating compounds having a relatively high log P value and retains compounds having a relatively low log P value. For instance, aliphatic compounds have a higher log P value than other components, and heteroatom containing organic compounds have correspondingly a lower log P value. This means that the membrane will allow aliphatic compounds to pass through by affinity. The determination of the Log P values of the feedstock components can be made by methods known in the art, and such information can be used to determine the selection of the functional group for the membrane. For instance, it is possible to select a polar functional group for functionalizing of the membrane surface. In that case, compounds with a relatively lower Log P would preferentially permeate through the membrane while compounds with a relatively higher Log P would remain in the retentate.

The membrane may be arranged as a mono-channel, multi-channel, hollow fiber (capillary) or spiral-wound membrane element. Suitably, in the present invention, the membrane is arranged in a tubular geometry, especially as a multi-channel membrane element. A membrane module comprises 2 or more of said membrane elements.

The membrane used in the process of the present invention may operate as a cross-flow membrane. Cross-flow filtration involves flowing the feed stream parallel, or tangentially, along a feed side of the membrane, rather than frontally passing through the membrane.

A parallel flow of feed, combined with turbulence created by the cross-flow velocity, continually sweeps away particles and other material that would otherwise build up on the membrane. In this way, cross-flow filtration creates a shearing effect on the surface of the membrane that prevents build-up of retained components and/or a potential fouling layer at the membrane surface. In the present invention, cross-flow filtration is preferred in order to prevent build-up of retained particles and/or a potential fouling layer on the membrane caused by physical or chemical interactions between the membrane and various components present in the feed.

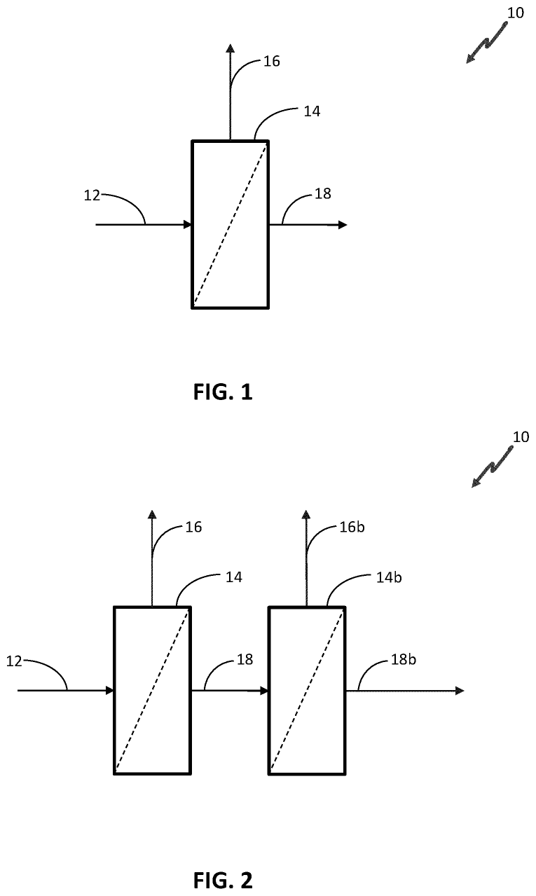

Referring now to FIGS. 1 and 2 which illustrate the polyol purification process of the present invention, in a process 10 a feed stream 12 of a polyether polyol as described above, which is prepared by ring-opening polymerization of an alkylene oxide in the presence of an initiator having a plurality of active hydrogen atoms, is fed to a filtration unit 14. A retentate stream 16 and a permeate stream 18 comprising the purified polyether polyol leave from the filtration unit 14.

In accordance with the present invention, a contaminant, which comprises above-described ultra-high molecular weight (UHMW) components from the polyether polyol is removed in the retentate stream 16 to provide a permeate stream 18 that has a reduced contaminant concentration as compared to the feed stream.

The preferred operating temperature range may be determined by the nature of the feed stream 12 to the filtration unit 14 for the lower limit and the temperature resistance of the membrane for the upper limit. Preferably, the filtration step is conducted at a temperature in a range of from 4 to 200° C., depending on the type of membrane used. For polymeric membranes, the filtration step is preferably conducted at a temperature in a range of from 4 to 150° C., more preferably in a range of from 20 to 110° C. For ceramic membranes and ceramic-based composite membranes, the filtration step is preferably conducted at a temperature in a range of from 20 to 200° C., more preferably in a range of from 60-200° C.

Differential pressure drives the permeating molecules through the membrane. The pressure of the feed stream 12 to the filtration unit 14 may be increased to a pressure in the range of from 5 to 100 bar (0.5 to 10 MPa), preferably of from 10 to 40 bar (1 to 4 MPa), more preferably of from 15 to 30 bar (1.5 to 3 MPa). The permeate stream 18 may have a pressure in the range of from 1 to 10 bar (0.1 to 1 MPa). The retentate stream 16 may have a pressure in the range of from 1 to 40 bar (0.1 to 4 MPa).

The permeate stream 18 may be stored in an intermediate storage and/or transport vessel before being further processed.

In the process 10 of FIG. 2, the permeate stream 18 from the filtration unit 14 is fed to a second staged filtration unit 14b. The membrane of the staged filtration unit 14b may be the same or different as in the filtration unit 14. For example, the membrane of filtration unit 14 may have a larger average pore size than that membrane of filtration unit 14b. For example, the membrane in filtration unit 14 may have an average pore size of 30 nm, while the membrane in filtration unit 14b may have an average pore size of 10 nm. As another example, the surface of the membrane in filtration unit 14 may have a different functional group, as compared to the membrane in filtration unit 14b. As yet another example, one of the membranes in filtration unit 14 or filtration unit 14b may be hydrophilic, while the other is organophilic.

Retentate stream 16b from the filtration unit 14b comprises at least a portion of the contaminants contained in the permeate stream 18. Permeate stream 18b from the filtration unit 14b comprises a permeate stream with reduced concentration of contaminants relative to the feed stream 12.

Preferably, the filtration unit 14, 14b, is operated with a periodic backpulse. A periodic backpulse of the membrane allows for ongoing cleaning of the membrane without the need for downtime. Preferably, the membrane is backpulsed with a pulse of pressure in a range of from 10 to 15 bar for a time in a range of from 1 to 5 seconds. The backpulse is preferably conducted on a periodic basis in a range of from 10 minutes to 30 minutes.

Further, the filtration step may comprise a backwash cycle, which involves changing the flow direction of fluid through the membrane to remove particles and/or an oily layer that have become attached to the membrane on the retentate side and/or that have become trapped in the openings of the membrane. After detaching in the backwash cycle, the particles and/or oily layer may then be removed via a retentate outlet and the normal filtration step may be resumed.

The change in flow direction in a backwash cycle may be achieved by having a cleaning fluid on the filtrate side of the membrane at a pressure that is higher than the pressure of the fluid to be filtered on the retentate side of the membrane. The pressure difference causes the cleaning fluid to flow through the membrane in a direction opposite to the direction of normal flow, that is to say, opposite to the direction of normal flow of the fluid to be filtered. Such “normal flow” refers to non-cleaning time periods.

The cleaning fluid used in the backwash cycle can be any fluid known to be suitable to a person skilled in the art. A cleaning fluid that is especially preferred is permeate resulting from the filtration step. It is especially advantageous to use permeate for cleaning the membrane by which the permeate has been obtained because in that way no additional compounds are introduced. This simplifies operation and/or reduces risk of contamination.

A backwash pump may be used for the backwash cycle. Alternatively, a backwash pressure difference may be achieved by reducing the pressure of the fluid to be filtered on the retentate side of the membrane to a pressure that is below the pressure of a cleaning fluid on the permeate side of the membrane. Such reduction in pressure can be achieved, for example, by removing overpressure or reducing the pressure to below atmospheric pressure. As the remainder of a filtration unit is generally at a substantially greater atmospheric pressure, it often suffices to lower the pressure of a retentate outlet to atmospheric pressure.

A backwash in the filtration step may be triggered in a variety of ways. For example, a backwash may be initiated once the pressure of the fluid to be filtered on the retentate side of the membrane increases to a predetermined threshold due to relatively large particles blocking a portion of the openings of the membrane. This is preferred in a case where the feed contains a relatively high amount of such large particles and/or where particles, such as phospholipids, are sticky and prone to penetrate (be dragged) into and thereby also block the openings of the membrane. A pressure-based self-cleaning backwash is preferred as in such case there is a minimal backwash usage due to its backwash efficiency. In conventional (non-self-cleaning) backwash, a substantially higher volume of washing solvent is to be used to achieve the same effect. In case the feed contains a relatively low amount of such large particles and/or sticky particles, a timer-based self-cleaning backwash (e.g. once per hour) may be more suitable.

In the purification process of the present invention, a permeate comprising a purified polyether polyol containing a reduced amount of ultra-high molecular weight (UHMW) components is produced. Advantageously, by said purification process, the UHMW content in the purified polyether polyol as present in such permeate may be substantially reduced. In the present invention, the purified (filtered) polyether polyol may contain ultra-high molecular weight (UHMW) components having molecular weights greater than 15,000 g/mol, suitably components having molecular weights in the range of from greater than 15,000 g/mol to 400,000 g/mol, in an amount which is at most 2,000 ppmw, preferably at most 1,500 ppmw, more preferably at most 1,000 ppmw, more preferably at most 500 ppmw, more preferably at most 300 ppmw, more preferably at most 100 ppmw, more preferably at most 50 ppmw, most preferably at most 20 ppmw. Further, said UHMW content may be 0 ppmw or at least 1 ppmw or at least 10 ppmw or at least 30 ppmw or at least 50 ppmw or at least 70 ppmw.

In the present invention, the purified (filtered) polyether polyol may contain UHMW components having molecular weights greater than 15,000 g/mol to 30,000 g/mol in an amount of at most 2,000 ppmw, suitably of from 1 to 1,000 ppmw, more suitably of from 20 to 500 ppmw. Further, said polyether polyol to be purified may contain UHMW components having molecular weights greater than 30,000 g/mol to 50,000 g/mol in an amount of at most 200 ppmw, suitably of from 1 to 150 ppmw, more suitably of from 10 to 100 ppmw. Further, said polyether polyol to be purified may contain UHMW components having molecular weights greater than 50,000 g/mol to 400,000 g/mol in an amount of at most 100 ppmw or at most 50 ppmw or at most 10 ppmw or preferably 0 ppmw.

As described hereinabove, so-called “EO-tipped” polyether polyols are polyether polyols wherein EO content is present at the ends of the polyether chains, and these are prepared by a process wherein in a final step ethylene oxide is added and a basic catalyst is used. Further, as also described, before such final step, a DMC catalyst may be used to provide for the first part of the polyether polyol, and after such final step, the thus obtained polyether polyol containing UHMW components, resulting from the DMC-catalysed polymerisation in the first part of the process, may be subjected to the purification process of the present invention.

It was surprisingly found that alternatively, the intermediate polyether polyol resulting from the first, DMC-catalysed part of the process for preparing “EO-tipped” polyether polyols may advantageously be subjected to the purification process of the present invention, in order to first remove the UMHW components, before carrying out the final polymerisation (“EO-tipping”) step using a basic catalyst.

Accordingly, the present invention also relates to a process for preparing a polyether polyol which has a molecular weight of at least 4,000 g/mol and a primary hydroxyl content of at least 30%, said process comprising ring-opening polymerization of an alkylene oxide comprising ethylene oxide in the presence of a polyether polyol obtained by the above-described purification process and a basic catalyst.

Thus, such “EO-tipped” polyether polyol obtained by the present polyether polyol preparation process is partly made using a DMC catalyst. In specific, such polyether polyol may be prepared by first preparing a polyether polyol using a DMC catalyst in a way as described above resulting in an EO content of at most 25 wt %, suitably of from 3 to 25 wt. %, a relatively low PHC of at most 25%, suitably of from 2 to 25%, followed by the purification process of the present invention, and finally by using a basic catalyst to further polymerize the purified polyether polyol, coming from the permeate obtained in said purification process, in a final step. Preferably, said basic catalyst is a potassium hydroxide (KOH) catalyst.

The above-mentioned final step comprises ring-opening polymerization of an alkylene oxide comprising ethylene oxide in the presence of (i) a basic catalyst and (ii) the purified polyether polyol prepared by using a DMC catalyst. The higher the relative amount of ethylene oxide in such final step, the higher the PHC of the resulting polyether polyol. It is preferred that in the final step, only ethylene oxide is added as alkylene oxide. The polyether polyol prepared by a process involving such final step, comprises polyether chains containing preferably at most 30 wt. %, more preferably at most 25 wt. %, most preferably at most 20 wt. % of ethylene oxide (EO) content. Further, preferably, such polyether polyol comprises polyether chains containing at least 5 wt., more preferably at least 8 wt. %, most preferably at least 12 wt. % of EO content. Still further, preferably, such polyether polyol has a primary hydroxyl content (PHC) which is at most 99% or at most 95% or at most 90% or at most 85% or at most 80%. Further, the PHC for such polyether polyol is at least 30% and may be at least 50% or at least 60% or at least 65% or at least 70% or at least 75%.

Further, the polyether polyol obtained in such polyether polyol preparation process of the present invention has a molecular weight of at least 4,000 g/mol, preferably at least 4,500 g/mol, more preferably at least 5,000 g/mol. Further, the molecular weight of said polyether polyol may be at most 10,000 g/mol, preferably at most 8,000 g/mol, more preferably at most 7,000 g/mol, most preferably at most 6,000 g/mol. Still further, for said “EO-tipped” polyether polyols, in the present invention, the weight ratio of alkylene oxide added when using the DMC catalyst to alkylene oxide added when using the basic catalyst may be of from 1:1 to 10:1, preferably of from 3:1 to 9:1, more preferably of from 4:1 to 8:1.

The present invention also relates to a process for preparing a polyurethane foam using the above-described filtered polyether polyol, which process comprises reacting said polyether polyol and a polyisocyanate in the presence of a blowing agent. Accordingly, the present invention also relates to a process for preparing a polyurethane foam, comprising reacting a polyether polyol obtained by the above-described purification process and a polyisocyanate in the presence of a blowing agent.

In the present polyurethane foam preparation process, it is preferred that the polyether polyol has a molecular weight of at least 4,000 g/mol and a primary hydroxyl content (PHC) of at least 30%. More preferably, said polyether polyol has a molecular weight of at least 4,500 g/mol, most preferably at least 5,000 g/mol. Further, preferably, said polyether polyol has a molecular weight of at most 10,000 g/mol, preferably at most 8,000 g/mol, more preferably at most 7,000 g/mol, most preferably at most 6,000 g/mol. Said polyether polyol may have a PHC of at least 50% or at least 60% or at least 65% or at least 70% or at least 75%. Further, said polyether polyol may have a PHC of at most 99% or at most 95% or at most 90% or at most 85% or at most 80%.

In the present polyurethane foam preparation process, the polyisocyanate may be an aromatic polyisocyanate or an aliphatic polyisocyanate, preferably an aromatic polyisocyanate.

The aromatic polyisocyanate may for example comprise tolylene diisocyanate (TDI) or polymeric TDI, xylylene diisocyanate, tetramethylxylylene diisocyanate, methylene diphenyl diisocyanate (MDI) or polymeric MDI (i.e. polymethylene polyphenyl isocyanate), or a modified product thereof. Preferably, the aromatic polyisocyanate comprises tolylene diisocyanate (TDI), i.e. non-polymeric TDI. The TDI may be a mixture of 80 wt. % of 2,4-TDI and 20 wt. % of 2,6-TDI, which mixture is sold as “TDI-80”.

Further, the aliphatic polyisocyanate may for example comprise hexamethylene diisocyanate, dicyclohexylmethane diisocyanate, lysine diisocyanate or isophorone diisocyanate, or a modified product thereof.

Further, the polyisocyanate may be any mixture of two or more of the polyisocyanates mentioned above. For example, the polyisocyanate may be a mixture of TDI and MDI, in particular a mixture wherein the weight ratio of TDI:MDI varies from 10:90 to 90:10.

In the present invention, the blowing agent may be a chemical blowing agent or a physical (non-chemical) blowing agent. Within the present specification, by “chemical blowing agent” reference is made to a blowing agent that may only provide a blowing effect after it has chemically reacted with another compound.

Preferably, in the present invention, the blowing agent is a chemical blowing agent. Further, preferably, the chemical blowing agent comprises water. Water reacts with isocyanate groups of the polyisocyanate, thereby releasing carbon dioxide which causes the blowing to occur. Further, preferably, substantially no physical (non-chemical) blowing agent is added in the present process.

However, other suitable blowing agents, such as for example, acetone, gaseous or liquid carbon dioxide, halogenated hydrocarbons, aliphatic alkanes and alicyclic alkanes may be employed additionally or alternatively.

Due to the ozone depleting effect of fully chlorinated, fluorinated alkanes (CFC's) the use of this type of blowing agent is generally not preferred, although it is possible to use them within the scope of the present invention. Halogenated alkanes, wherein at least one hydrogen atom has not been substituted by a halogen atom (the so-called HCFC's) have no or hardly any ozone depleting effect and therefore are the preferred halogenated hydrocarbons to be used in physically blown foams. One suitable HCFC type blowing agent is 1-chloro-1,1-difluoroethane.

In the present invention, in a case where the blowing agent comprises water, water may be used in an amount of from 0.1 to 10 parts per hundred parts by weight of polyol (pphp), more preferably of from 0.5 to 8 pphp, more preferably of from 1 to 6 pphp, more preferably of from 1.5 to 4 pphp. In case of halogenated hydrocarbons, aliphatic alkanes and alicyclic alkanes, the amount of the blowing agent may be of from 1 to 50 parts per hundred parts by weight of polyol (pphp), suitably of from 1 to 30 pphp, more suitably of from 1 to 20 pphp.

The above blowing agents may be used singly or in mixtures of two or more.

In the present process, the isocyanate index (or NCO index) may be at most 150, more suitably at most 140, more suitably at most 130, more suitably at most 125, most suitably at most 120. The isocyanate index is preferably higher than 90, more preferably higher than 100, most preferably higher than 105.

Within the present specification, “isocyanate index” is calculated as 100 times the mole ratio of —NCO groups (isocyanate groups) to NCO-reactive groups in the reaction mixture. In other words, the “isocyanate index is defined as: [(actual amount of isocyanate)/(theoretical amount of isocyanate)]*100, wherein the “theoretical amount of isocyanate” equals 1 equivalent isocyanate (NCO) group per 1 equivalent isocyanate-reactive group.

Such “isocyanate-reactive groups” as referred to above include for example OH groups from the polyether polyols and from any water that may be used as a blowing agent. Isocyanate groups also react with water.

Additionally, other components may also be present during the polyurethane foam preparation process of the present invention, such as one or more polyurethane catalysts, surfactants and/or cross-linking agents.

Polyurethane catalysts are known in the art and include many different compounds. For the purpose of the present invention, suitable catalysts include tin-, lead- or titanium-based catalysts, preferably tin-based catalysts, such as tin salts and dialkyl tin salts of carboxylic acids. Specific examples are stannous octoate, stannous oleate, dibutyltin dilaureate, dibutyltin acetate and dibutyltin diacetate. Other suitable catalysts are tertiary amines, such as, for instance, bis(2,2′-dimethylamino)ethyl ether, trimethylamine, triethylamine, triethylenediamine and dimethylethanolamine (DMEA). Examples of commercially available tertiary amine catalysts are those sold under the tradenames Niax, Tegoamin and Dabco (all trademarks). The catalyst is typically used in an amount of from 0.01 to 2.0 parts by weight per hundred parts by weight of polyether polyol (pphp). Preferred amounts of catalyst are from 0.05 to 1.0 pphp.

The use of cross-linking agents in the production of polyurethane foams is also well known. Polyfunctional glycol amines are known to be useful for this purpose. The polyfunctional glycol amine which is most frequently used and is also useful in the preparation of polyurethane foams, especially flexible polyurethane foams, is diethanol amine, often abbreviated as DEOA. If used at all, the cross-linking agent is applied in amounts up to 4 parts by weight per hundred parts by weight of polyol (pphp), but amounts in the range of from 0.01 to 2 pphp are more suitably applied, most suitably 0.01 to 0.5 pphp.

In addition, other well-known auxiliaries, such as colorants, flame retardants and fillers, may also be used during the polyurethane foam preparation process of the present invention. In specific, an auxiliary which promotes cell opening may also be used during the polyurethane foam preparation process of the present invention.

The present polyurethane foam preparation process may involve combining the polymer polyol, the polyisocyanate, the blowing agent, a foam stabiliser, a catalyst and optionally crosslinker, flame retardant, colorant and/or filler, in any suitable manner to obtain the polyurethane foam. For example, the present process may comprise stirring the polymer polyol, the blowing agent, a foam stabiliser, a catalyst and any other optional component(s) except the polyisocyanate together for a period of at least 30 seconds; and adding the polyisocyanate under stirring.

Further, the process of the invention may comprise forming the foam into a shaped article before it fully sets. Suitably, forming the foam may comprise pouring the liquid mixture containing all components into a mould before gelling is complete.

In specific, in the process of the invention, the foam may be formed into a shaped article in any known way. In one embodiment, the liquid mixture containing all components may be poured into a mould wherein the foam expansion in the vertical direction is not restrained, for example wherein the mould is a box which is opened at the top side. This is generally referred to as “free rise” and the thus obtained foam as “slabstock” foam. In another embodiment, the liquid mixture containing all components may be poured into a mould wherein the foam expansion is restrained in all directions, for example wherein the mould is a container which is closed, for example with a lid. The foam obtained in the latter embodiment is generally referred to as “moulded” foam.

The present invention also relates to a polyurethane foam obtainable by the above-described process, and to a shaped article comprising said polyurethane foam.

In the invention as described above, a polyether polyol is purified or used. However, the invention is also applicable to cases wherein, instead of a polyether polyol, a polycarbonate polyol or a polyester polyol is purified or used. Further, the invention is applicable to cases wherein a recycled polyol is purified or used.

The invention is further illustrated by the following Examples.

### Examples

Materials (polyether polyols, polyisocyanate and other components) used in the experiments, including polyurethane foam experiments, are described in Table 1 below.

TABLE 1

| | |
|---|---|
| | POLYETHER POLYOLS |
| Polyol A | Made by ring-opening polymerization of alkylene |
| | oxide in the presence of DMC catalyst, monopropylene |
| | glycol and glycerol: MW = 2,800 g/mol; OH number = |
| | 56 mg KOH/g; EO content = 7.8 wt. %; PO content = |
| | 89.1 wt. %; PHC = 11%; EO and PO randomly |
| | distributed; functionality = 2.8; kinematic |
| | viscosity (at 20° C.) = 800 mm²/s |
| Polyol B | Made by ring-opening polymerization of alkylene |
| | oxide in the presence of KOH catalyst and glycerol: |
| | MW = 3,500 g/mol; OH number = 48 mg KOH/g; EO |
| | content = 10.5 wt. %; PO content = 86.7 wt. %; PHC = |
| | 3%; EO and PO randomly distributed; functionality = |
| | 2.8; kinematic viscosity (at 20° C.) = 960 mm²/s |
| Polyol D | Made by ring-opening polymerization of alkylene |
| | oxide in the presence of KOH catalyst and glycerol: |
| | MW = 4,700 g/mol; OH number = 36 mg KOH/g; EO |
| | content = 18.0 wt. %; PO content = 80.0 wt. %; PHC = |
| | 86%; EO tipped; functionality = 2.4; kinematic |
| | viscosity (at 20° C.) = 1,110 mm²/s |
| Polyol E | Dispersion of styrene-acrylonitrile (SAN) based |
| | polymer (solid content = 40 wt. %) in Polyol D |
| Polyol F | Mixture of Polyol E and Polyol D in a weight ratio |
| | of 70:30 |
| | POLYISOCYANATE |
| TDI-80 | 80:20 (by weight) blend of 2,4- and 2,6-isomers of |
| | TDI (tolylene diisocyanate) commercially available |
| | from Mitsui; free NCO content = 48.3% |
| | OTHER COMPONENTS |
| T-9 | Stannous octoate catalyst, commercially available |
| | from Air Products and Chemicals |
| Dabco | Catalyst which is a mixture of 33 wt. % of 1,4- |
| 33-LV | diazabicyclooctane and 67 wt. % of oxydipropanol, |
| | commercially available from Air Products and |
| | Chemicals |
| Niax A33 | Amine based catalyst available from Momentive |
| | Performance Materials |
| Niax A1 | Amine based catalyst available from Momentive |
| | Performance Materials |
| Tegostab | Silicone based surfactant commercially available |
| B8681 | from Evonik. |
| Diethanolamine | Cross-linking agent |

DMC = double metal cyanide;
KOH = potassium hydroxide;
EO = ethylene oxide;
PO = propylene oxide;
EO and PO contents based on total polyol weight;
MW = molecular weight;
PHC = primary hydroxyl content

In the polyurethane foam experiments, the non-polyisocyanate components were mixed in a high-speed mixer at about 800 rpm for 40 seconds. Then the polyisocyanate component was added and the mixture was stirred for around 5 seconds and then poured into a box of dimensions of 1 m*1 m*1 m to form a polyurethane foam. The full rise time, the maximum full rise height and any sink back of the foam were measured. The full rise time was the time period between the time of adding the polyisocyanate and the time at which the maximum full rise height was achieved. The sink back was measured at 360 seconds after having added the polyisocyanate. Said sink back was equal to the maximum full rise height—the height at 360 seconds after having added the polyisocyanate. The relative sink back (%) was also determined, which was equal to (sink back/maximum full rise height)*100.

Still further, the foam was sliced as per the requirements and one or more of the following physical properties of the foam were measured:
1) Density according to ASTM D3574 (sample size 100*100*50 mm³, 2 samples/foam).
2) Porosity.
3) Hardness Compression Load Deflection at 40% compression (CLD40%) according to DIN 53577 (sample size 100*100*50 mm³, 2 samples/foam), which involves measuring the force required to compress a sample by 40%.
4) Resilience according to ASTM D3574—Test H (sample size 100*100*50 mm³, 2 samples/foam), which involves dropping a 16 mm diameter steel ball bearing onto a sample and measuring the percentage height that the ball bearing rebounded.

In case of foam collapse (as observed visually), the maximum full rise height, the (exact) extent of the sink back and some of the above-mentioned physical properties were not always measured.

### 1. Polyol Filtration Experiments

In these experiments, a polyether polyol made by ring-opening polymerization of alkylene oxide in the presence of a DMC (double metal cyanide) catalyst was subjected to filtration using a membrane. The results for filtration of DMC-catalysed Polyol A are shown in Table 2 below.

The driving force for filtration is the trans membrane pressure (TMP) which is the average pressure difference between the feed and the permeate. Two parameters are used to describe membrane processes: (i) rejection and (ii) permeate yield or permeate recovery. The rejection is a measure for selectivity and shows how well a solute is retained by the membrane, i.e. not permeated through the membrane. The other parameter important for an application is the permeate yield or permeate recovery which is calculated as follows:

Permeate yield or recovery (in wt. %)=[mass(flow)permeate/mass(flow)feed]*100

In most cases, it is preferred that the permeate yield is as high as possible, as the permeate usually comprises the desired component. However, at a very high permeate yield the permeate quality may be negatively affected.

In these experiments, Inopor® ceramic membranes with a mesoporous titania (TiO₂) top layer were used to filter above-mentioned DMC-catalysed polyether polyol Polyol A. The filtration experiments were carried out using a multi-channel membrane element, with each membrane element having 19 channels with an inner diameter of 3.5 mm and a length of 120 cm, wherein the membrane had a pore size of 5 nm. This resulted in a membrane surface of 0.25 m². Three of these membrane elements together constituted one membrane module which was used for the tests.

Each membrane element had a circulation flow of 0.66 m³/hr to realize a linear velocity of 1 m/s. Hence the 3 parallel membrane elements had a (total) circulation flow of 1.98 m³/hr for a linear velocity of 1 m/s. The circulation flow was varied to 3.86 m³/hr, which resulted in a linear velocity of 1.9 m/s.

The filtration was carried out at a constant temperature (120° C.) and a trans membrane pressure of 15 bar, and the permeate was collected at four different recovery rates: 10, 50, 65 and 80 wt. %. The retentate was also collected at each of these permeate recoveries. In Table 1, the viscosities of the permeates and retentates are shown for filtered Polyol A (see Experiments 1.1-1.4).

TABLE 2

| | |
|---|---|
| Permeate | Kinematic viscosity |
| recovery | (at 20° C.; mm²/s) |

| Experiment | (wt. %) | Permeate | Retentate |
|---|---|---|---|
| 1.1 | 10% | 630 | 825 |
| 1.2 | 50% | 680 | 1,025 |
| 1.3 | 65% | 710 | 1,200 |
| 1.4 | 80% | 790 | 1,800 |

As can be seen from Table 2 above, when subjecting DMC-catalysed polyether polyol (Polyol A) to above-described filtration (in Experiments 1.1-1.4), a permeate and retentate with different viscosities were obtained. Furthermore, the permeate viscosity for the filtered DMC-catalysed polyether polyol was reduced, as compared to the viscosity of that same polyol before filtration (which was 800 mm²/s), at all tested recovery rates. Similarly, the retentate viscosity increased proportionally.

In another filtration experiment, the amount of ultra-high molecular weight (UHMW) components, having molecular weights greater than 15,000 g/mol, in the polyether polyol (feed) before filtration and in the permeate after filtration were measured. This other filtration experiment was performed in the same way as the above-described filtration experiment at a permeate recovery of 50 wt. %, except that the pore size of the membrane was 10 nm (not 5 nm). The UHMW contents of Polyol A before and after such filtration experiment were measured by high-performance liquid chromatography (HPLC). The measurement results are included in Table 3 below, wherein the molecular weight (“MW”) is expressed in “kDa” which stands for “kilo Dalton” (=103 g/mol) and the UHMW content is expressed in “ppmw” which stands for “parts per million by weight”.

TABLE 3

| UHMW | MW (kDa) | | | |
|---|---|---|---|---|
| content (ppmw) | >15 to 30 | >30 to 50 | >50 to 100 | >100 to 400 |
| Before | 3,228 | 244 | 50 | 12 |
| After [permeate] | 93 | 0 | 0 | 0 |

As can be seen from Table 3 above, filtration in accordance with the present invention, comprising filtering the polyether polyol with a membrane having an average pore size of from 0.5 to 80 nm, surprisingly and advantageously enables the removal of the above-mentioned UHMW components from a polyether polyol prepared using a composite metal cyanide complex catalyst (DMC catalyst), thereby producing a permeate comprising a purified polyether polyol containing a reduced amount of UHMW components.

In addition, as demonstrated below, such filtration in accordance with the present invention surprisingly and advantageously enables the prevention of polyurethane (PU) foam instability issues (e.g. foam sink back and foam collapse) when using the thus purified (filtered) polyether polyol from the resulting permeate.

### 2. Use of Filtered Polyol in PU Foam Experiments

Polyol A was used in experiments for making polyurethane (PU) foams. The following polyols were tested in said experiments: 1) Polyol A which had not been filtered; 2) Polyol A which had been filtered using a membrane having an average pore size of 5 nm, 10 nm or 100 nm. Said 3 membranes were the same as the above-described membrane, with the exception of the different pore sizes. Further, an (unfiltered) polyether polyol similar to Polyol A but made by using a KOH catalyst (not a DMC catalyst as for Polyol A), namely Polyol B, was also used to make a PU foam in the same way.

Only a relatively small amount (3 pbw=3 parts by weight) of the above-mentioned polyether polyol was added (“spiked”) to 100 pbw of another polyether polyol (i.e. Polyol F), as indicated in Table 4 below. In the case of the filtered polyols, the polyether polyol obtained in the permeate from the above-described filtration experiment as performed at a 50 wt. % permeate recovery, was used in the foam experiments.

TABLE 4

| | 2.1 | 2.2 | 2.3 | 2.4 (*) | 2.5 (*) |
|---|---|---|---|---|---|
| Experiment | | | | | |
| Polyol F (pbw) | 100 | 100 | 100 | 100 | 100 |
| Polyol A or B (pbw) | B: 3 | A: 3 | A: 3 | A: 3 | A: 3 |
| Spike polyol filtered? | No | No | Yes: 100 nm | Yes: 10 nm | Yes: 5 nm |
| Water (pbw) | 3 | 3 | 3 | 3 | 3 |
| T-9 (pbw) | 0.15 | 0.15 | 0.15 | 0.15 | 0.15 |
| Niax A33 (pbw) | 0.08 | 0.08 | 0.08 | 0.08 | 0.08 |
| Niax A1 (pbw) | 0.04 | 0.04 | 0.04 | 0.04 | 0.04 |
| Tegostab B8681 (pbw) | 0.6 | 0.6 | 0.6 | 0.6 | 0.6 |
| Diethanol amine (pbw) | 1 | 1 | 1 | 1 | 1 |
| TDI-80 (isocyanate index) | 105 | 105 | 105 | 105 | 105 |
| Properties | | | | | |
| Full rise time (s) | 143 | 93 | 92 | 150 | 145 |
| Maximum full rise height (mm) | 373.1 | 361.6 | 357.4 | 375.4 | 383.3 |
| Sink back (mm) | 4.4 | 287.2 | 286.2 | 5.2 | 5.2 |
| Relative sink back (%) | 1.2 | 79.4 | 80.1 | 1.4 | 1.4 |
| Density (kg/m³) | 27.6 | ND | ND | 28.7 | 28.4 |
| Porosity (liters/min) | 69 | ND | ND | 68 | 78 |
| CLD40% (kPa) | 2.85 | ND | ND | 2.70 | 2.80 |

(*) = according to invention;
pbw = parts by weight;
ND = not determined

The major polyether polyol used in the PU foam experiments from Table 4 above was Polyol F which is a so-called high-resilience (HR) polymer polyol, wherein the base polyol (Polyol D) is a KOH-catalysed (not DMC-catalysed) polyether polyol having a relatively high molecular weight (4,700 g/mol) and a relatively high primary hydroxyl content (86%).

From Table 4 above, it appears that by adding a polyether polyol made by DMC catalysis (Polyol A), when making a PU foam from an HR polyol (Polyol F), a severe foam sink back occurs if that DMC-catalysed polyol is not first subjected to a filtration treatment in accordance with the present invention, using a membrane having an average pore size of from 0.5 to 80 nm, as shown by Experiment 2.2 (no filtration) and Experiment 2.3 (100 nm filtration) showing unacceptable foam sink back percentages of 79% and 80%, respectively. Such high foam sink back may also be referred to as a foam collapse. Such high foam sink back occurred even though the amount of Polyol A (3 pbw) was relatively low as compared to that of Polyol F (100 pbw). Further, such high foam sink back did not occur in the case wherein instead of DMC-catalysed Polyol A, KOH-catalysed Polyol B was added, in the same small amount, as in Experiment 2.1.

However, surprisingly and advantageously, by first subjecting such DMC-catalysed polyol (Polyol A) to a filtration treatment in accordance with the present invention, acceptable foam sink back percentages were achieved. In both Experiment 2.4 (10 nm filtration) and Experiment 2.5 (5 nm filtration), the sink back percentage was only 1.4%. Moreover, said sink back percentage was comparable to the sink back percentage obtained when using a similar, but unfiltered and KOH-catalysed polyol (Experiment 2.1:1.2%).

This means that surprisingly and advantageously, when using a DMC-catalysed polyol instead of a KOH-catalysed polyol in making a PU foam, which DMC catalyst use has significant advantages over using a KOH catalyst as described in the introduction of this specification, there is no incompatibility issue in terms of foam instability, such as a relatively high foam sink back including a foam collapse, especially in making a high-resilience (HR) PU foam, because of the pre-filtration treatment of the DMC-catalysed polyol as required in the present invention.

### 3. Use of Filtered Polyol in Preparing EO-Tipped Polyether Polyol by KOH Catalysis

The polyether polyol obtained in the permeate from the above-described filtration experiment as performed at a 50 wt. % permeate recovery, was further reacted with alkylene oxide using potassium hydroxide (KOH) as the catalyst. Further, as a reference, the unfiltered polyether polyol (i.e. Polyol A) was also subjected to a KOH-catalysed further alkoxylation. Said filtered or unfiltered Polyol A is hereinbelow also referred to as “intermediate” polyol.

The intermediate polyol (in an amount indicated in Table 5 below) was charged to a reactor and a 50 wt. % KOH aqueous solution (amount indicated in Table 5 below) was added. The reactor mixture was heated to 125° C. and stirred. Nitrogen was passed through the reactor contents and vacuum was gradually applied to remove water. Once a good and stable vacuum was obtained, a sample was taken to measure residual moisture. When the moisture was less than 500 ppm, the temperature was reduced to 110° C. and propylene oxide (PO) was added at the rate of 1,600 g/hr (total added PO amount indicated in Table 5 below). The reactor pressure increased throughout the PO addition and after PO addition was finished, the pressure stabilized to a constant value, indicating all PO had reacted. Then nitrogen (N₂) was added and the reactor contents were stripped to remove all traces of unreacted PO. Then the temperature of the reactor was adjusted to 130° C. and N₂ was added to set the reactor pressure to 1.6 bara. EO was then added at a rate of 1,300 g/hr (total added EO amount indicated in Table 5 below). All EO was reacted away which was confirmed by the pressure stabilizing to a constant value. Nitrogen was then added into the reactor and the reactor contents were then stripped for 30 minutes to remove all traces of unreacted oxides. The reactor contents were then neutralized with an 85 wt. % phosphoric acid aqueous solution such that the P/K (phosphorus/potassium) ratio was 0.96. Then water was added such that the concentration of the resulting brine was 15 wt. % (of salts). Reactor contents were then stirred for 150 minutes at 135° C. The water was then stripped under vacuum to crystallize potassium phosphate salts. The contents were then filtered thereby removing the crystallized salts, and the polyol product was collected.

Properties of the resulting polyol products, which are EO/PO-based, EO-tipped polyether polyols, are shown in Table 6 below.

TABLE 5

| | | Amount | Amount | Total | Total |
|---|---|---|---|---|---|
| | Intermediate | intermediate | KOH | added | added |
| | polyol | polyol | solution | PO | EO |
| Experiment | filtered? | (g) | (g) | (g) | (g) |
| 3.1 (*) | Yes | 4,572 | 102.2 | 3,578 | 1,335 |
| 3.2 | No | 4,572 | 102.2 | 3,578 | 1,335 |
| 3.3 (*) | Yes | 3,591 | 76 | 3,874 | 1,312 |
| 3.4 | No | 3,591 | 76 | 3,874 | 1,312 |

(*) = according to invention

TABLE 6

| | MW | OH number | EO content | PO content | PHC | | Unsats |
|---|---|---|---|---|---|---|---|
| Experiment | (g/mol) | (mg KOH/g) | (wt. %) | (wt. %) | (%) | Functionality | (meq/g) |
| 3.1 (*) | 5,000 | 32.2 | 18.4 | 79.7 | 85.7 | 2.4 | 0.053 |
| 3.2 | 5,000 | 33.0 | 18.4 | 79.7 | 86.5 | 2.4 | 0.055 |
| 3.3 (*) | 6,000 | 29.2 | 18.1 | 80.0 | 85.3 | 2.2 | 0.060 |
| 3.4 | 6,000 | 29.0 | 18.1 | 80.0 | 85.2 | 2.2 | 0.065 |

(*) = according to invention; EO and PO contents based on total polyol weight;
“Unsats” refers to degree of unsaturation

4. Use of EO-Tipped Polyether Polyol Prepared from Filtered Polyol in PU Foam Experiments

The above-mentioned EO/PO-based, EO-tipped polyether polyols, prepared from either filtered Polyol A or unfiltered Polyol A as intermediate polyol, were used in experiments for making polyurethane (PU) foams.

TABLE 7

| | 4.1 (*) | 4.2 |
|---|---|---|
| Experiment | | |
| Polyol E (pbw) | 30 | 30 |
| Polyol from Exp. 3.1 (pbw) | 70 | 0 |
| Polyol from Exp. 3.2 (pbw) | 0 | 70 |
| Water (pphp) | 3.2 | 3.2 |
| Dabco 33-LV (pphp) | 0.11 | 0.11 |
| Niax A33 (pphp) | 0.12 | 0.12 |
| Tegostab B8681 (pphp) | 0.8 | 0.8 |
| Diethanol amine (pphp) | 1.5 | 1.5 |
| TDI-80 (pphp) | 41 | 41 |
| Properties | | |
| Full rise time (s) | 133 | 177 |
| Maximum full rise height (mm) | 168.6 | ND |
| Sink back (mm) | 1.9 | collapse |
| Relative sink back (%) | 1.1 | ND |
| Density (kg/m³) | 27.5 | 26.5 |
| Porosity before crush (lpm) | 7 | ND |
| Porosity after crush (lpm) | 89 | ND |
| CLD40% (kPa) | 2.05 | 2.47 |
| Resilience (%) | 50 | 46 |

(*) = according to invention;
pbw = parts by weight;
pphp = parts per 100 parts of polyol (by weight);
lpm = liters/minute;
ND = not determined

From Table 7 above, it appears that by adding an EO/PO-based, EO-tipped polyether polyol, prepared from an intermediate polyol made by DMC catalysis (Polyol A), when making a high-resilience (HR) PU foam, a severe foam sink back (even a foam collapse) occurs if that DMC-catalysed polyol (Polyol A) is not first subjected to a filtration treatment in accordance with the present invention, using a membrane having an average pore size of from 0.5 to 80 nm, as shown by Experiment 4.1 (5 nm filtration of intermediate polyol) and Experiment 4.2 (no filtration). Experiment 4.2 resulted in an unacceptable foam collapse. However, by subjecting such DMC-catalysed intermediate polyol (Polyol A) to a filtration treatment in accordance with the present invention, an acceptable foam sink back percentage was achieved in the polyurethane foam experiment (Experiment 4.1:1.1%).

This means that surprisingly and advantageously, when using a polyol, which is prepared in the presence of a DMC catalyst, in making a PU foam, which DMC catalyst use has significant advantages over using a KOH catalyst as described in the introduction of this specification, there is no incompatibility issue in terms of foam instability, such as a relatively high foam sink back including a foam collapse, especially in making a high-resilience (HR) PU foam, because of the pre-filtration treatment of the DMC-catalysed polyol as required in the present invention.

1. A process for purification of a polyether polyol which is prepared by ring-opening polymerization of an alkylene oxide in the presence of an initiator having a plurality of active hydrogen atoms and a composite metal cyanide complex catalyst, has a number average molecular weight of at most 10,000 g/mol and contains ultra-high molecular weight (UHMW) components having molecular weights of at least 3 times the number average molecular weight,
said process comprising filtering the polyether polyol with a membrane having an average pore size of from 0.5 to 80 nm to produce a permeate comprising a purified polyether polyol containing a reduced amount of UHMW components.

2. The process according to claim 1, wherein the membrane has an average pore size of from 0.5 to 25 nm.

3. The process according to claim 1, wherein the membrane is a ceramic membrane.

4. The process according to claim 1, wherein the polyether polyol to be purified has a number average molecular weight of from 1,000 to 10,000 g/mol.

5. The process according to claim 1, wherein the polyether polyol to be purified contains UHMW components having molecular weights greater than 15,000 g/mol in an amount of from 100 to 10,000 parts per million by weight (ppmw).

6. A process for preparing a polyether polyol which has a molecular weight of at least 4,000 g/mol and a primary hydroxyl content of at least 30%, said process comprising ring-opening polymerization of an alkylene oxide comprising ethylene oxide in the presence of a polyether polyol obtained by the process according to claim 1 and a basic catalyst.

7. A process for preparing a polyurethane foam, comprising reacting a polyether polyol obtained by the process according to claim 1 and a polyisocyanate in the presence of a blowing agent.

8. The process according to claim 7, wherein the polyether polyol has a molecular weight of at least 4,000 g/mol and a primary hydroxyl content of at least 30%.

9. A polyurethane foam obtainable by the process of claim 7.

10. A shaped article comprising the polyurethane foam of claim 9.
